(19) United States
(12) Patent Application Publication
(10) Pub. No.: US 2003/0215307 A1
(43) Pub. Date: Nov. 20, 2003

(54) Pin cap

(76) Inventors: Andrew D. Markiewitz, Little Rock, AR (US); Harris Gellman, Weston, FL (US)

Correspondence Address: Ray F. Cox, Jr., Wright, Lindsey & Jennings LLP, Suite 2200, 200 West Capitol Avenue, Little Rock, AR, 72201, US

(21) Appl. No.: 10/151,453

(22) Filed: May 20, 2002

(51) Int. Cl. F16B 21/18

(52) U.S. Cl. 411/526

(57) ABSTRACT

A pin cap to protect the end of a pin that is usable with a range of pin sizes. The pin cap has a generally cylindrical shape with a closed end and an open end. The open end may have a tapered entry to facilitate insertion of the pin end into the pin cap. The interior of the body of the pin cap has a plurality of concave diaphragms with stellate center cuts. A pin is directed toward the center of each diaphragm while compression of the pin body compresses the diaphragms, thereby allowing the stellate center cut to open to allow the pin to pass through the diaphragm. When pressure on the pin body is relaxed, the stellate center cuts close down on the pin to hold it in place. By selecting the type of material used for the diaphragms, the number of diaphragms and the number of slots in the stellate center cut, the resistance of the pin cap to being pulled off the pin can be set. The concave shape of the diaphrams also resists removal of the pin cap from a pin. The internal side of the top of the pin cap may be textured with a “latticed” or “waffled” surface to provide a point of fixation for the end of the pin. The pin cap may be injection molded with the internal diaphragms being an integral part of the body, or alternatively, the diaphragms may be free floating between internal ledges within the body.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates to a device for covering the ends of wires, pins, rods, screws, bolts and the like and, in particular, to such a device which may be removed and replaced a number of times and which can accommodate a range of sizes of such wires, pins, rods, screws, bolts and the like. The device is particularly suited for use in covering wires and pins used in surgery and may be removed and replaced as necessary both during and after surgery.

2. Brief Description of the Related Art

Multiple wire and pin sizes are used casually in surgery. They are necessary for surgical procedures both during and after the procedure. However, such pins and wires are sharp and contaminated by blood products. It is, therefore, necessary to cover wires or pins placed during surgery in order to protect the surgeon and later the patent and caregivers from injury.

A standard pin cap fits only one pin size. Some require tools for application and removal. The loss of the tool hinders the application. Other pin caps slide on and off too easily to account for during surgery. The inventory balloons when one needs multiple caps per pin size. When it becomes troublesome to apply or remove a pin cap, the surgeon hesitates to use them. The presence of uncovered sharp pins/wires during surgery are a significant health risk to medical personnel in the operating room. After surgery, many patients require wound care for months. Exposed pins continue to be a risk to the patient, their caregiver, and other healthcare professionals. Injury and disease transmission pose a serious risk in this era of HIV and Hepatitis.

The prior art of pin caps includes a spherical cap with a set screw in its side. This device requires a tool to attach and remove the cap and thus is clumsy to use during surgery when a pin cap may require removal and replacement a number of times. This device is also designed to be used with a limited range of pin sizes. Therefore, it is necessary to for the surgeon to have access to a range of pin caps of varying size. Another prior art device cannot be removed after being placed on a wire or pin. If the device must be removed, the wire or pin must be cut instead.

Information relevant to attempts to address these problems can be found in various U.S. patents. However, each of these devices suffers from one or more disadvantages as discussed below.

There are various patents for devices that protect the end of an exposed surgical pin or wire without actually forming a cap on the end of the pin or wire. See, for example, U.S. Pat. Nos. 6,183,452; 5,752,952; and 5,499,982.

There are also devices that are affixed to the end of the pin or wire by set screws. Examples of this category of pin caps are U.S. Pat. No. 5,300,072; D373,632; and D367,529. U.S. Pat. No. 5,330,476 and corresponding Japanese Patent JP6181932 disclose a variation of this type of device in which the screw is locked into the cap by the fracture of an embrittled zone.

Another category of pin protectors comprises simple plastic buttons that have a bore partially through the button, the bore being sized to fit onto a given gauge of wire and to be held there by friction. U.S. Pat. No. 5,354,301 appears to disclose this type of pin cap. This patent discloses a pin cap with a cone shaped entrance to allow for error in the pin angle. Another pin cap of this type is shown in D321,401.

U.S. Pat. No. 3,809,075 does not strictly relate to a device for protecting the end of a surgical wire or pin. Instead, this patent discloses a retainer to prevent a wire from migrating into the patient's body. The retainer is made of a soft metal, such as lead, which is squeezed around the end of an exposed wire.

U.S. Pat. No. 5,850,670 discloses a bushing for use in plastic molds. In this type of mold, one half of the mold is provided with leader pins which fit into hollow bushings in the other half of the mold. The problem is that thermal expansion of the mold halves may cause misalignment of the pins with the bushings. The solution offered in this patent is to provide a bushing with an internal liner that has some freedom of movement within the body of the bushing. The liner is therefore able to adjust to accommodate misaligned pins. The liner is centered in the body of the bushing by springs or other resilient members.

U.S. Pat. No. 5,300,075 discloses a cap for orthopedic splinting rods. The cap is a metal cylinder with a longitudinal slit up one side and a curved top. The cap is attached to the end of the splinting rod by rotating the cap so that the burred end of the splinting rod cuts a spiral groove in the manner of screw threads into the inside of the cap. The cap narrows toward the top to ensure increasing pressure on the end of the splinting rod as it is screwed into the cap. A version of the cap for external use encases the metal cap into a plastic housing. A version with the plastic housing is disclosed in design patent no. D342,315.

U.S. Pat. No. 4,688,560 to Schultz discloses one embodiment of a pin cap which has a wire coil with a diameter decreasing from the open end of the cap to the closed end. The configuration is similar to the device used to join electrical wires and called a “wire nut.” Another configuration has prongs projecting internally and inwardly. The prongs are angled to allow for easy insertion of the cap but provide resistance to removal since it is noted that the prongs tend “to force themselves into the surface of the wire.”

References mentioned in this background section are not admitted to be prior art with respect to the present invention. The limitations of the prior art are overcome by the present invention as described below.

### BRIEF SUMMARY OF THE INVENTION

The present invention overcomes the problems of the prior art by providing for a pin cap that can be employed with a wide range of pin sizes and which can be removed and replaced a number of times. The term “pin” as used herein is intended to refer to pins, wires, rods, screws, bolts and the like which may require a cover or cap on the end of such. The pin cap of the present invention has a generally cylindrical shape with one end closed and the other end open. The open end may have a tapered entry in order to make the insertion of the pin end into the pin cap easier and to provide a point of fixation at one point on the pin.

The interior of the body of the pin cap has a plurality of concave diaphragms. The diaphragms are cut in a stellate pattern from the center. When a pin enters the pin cap, the pin is directed toward the center of each diaphragm in turn. Compression of the pin body compresses the diaphragms, thereby forcing the center cuts to open to allow the pin to pass through the diaphragm. When pressure on the pin body is relaxed, the central opening closes down on the pin to hold it in place.

By selecting the type of material used for the diaphragms, the number of diaphragms and the number of cuts in the central opening, the resistance of the pin cap to being pulled off the pin can be set. The concave shape of the diaphrams also resists removal of the pin cap from a pin.

The internal side of the top of the pin cap may be roughened with a “latticed” or “waffled” surface to provide a point of fixation for the end of the pin. In one embodiment, the pin cap may be injection molded with the internal diaphragms being an integral part of the body.

In an alternative embodiment, the diaphragms are free floating between internal ledges within the body.

These and other features, objects and advantages of the present invention will become better understood from a consideration of the following detailed description of the preferred embodiments and appended claims in conjunction with the drawings as described following.

### BRIEF DESCRIPTION OF THE SEVERAL VIEWS OF THE DRAWINGS

FIG. 1 is partial sectional view of a human arm showing a pin fixing a fractured bone, the exposed ends of the pin terminated by the pin cap of the present invention.

FIG. 2 is a perspective view of the pin cap of the present invention showing the tapered entry for funneling the pin end into the pin cap and through the stellate center cuts in the diaphragm.

FIG. 3 is a cross-sectional perspective view of the pin cap showing an internal diaphragm. This view also shows the ledge of the tapered entry that prevents pull out of the diaphragms from the pin cap.

FIG. 4 is a cross-sectional side elevation view along the line 4-4 of FIG. 2 showing a pin in shadow outline penetrating the stellate center cut of the diaphragm.

FIG. 5 is a rear elevation view of the pin cap and diaphragm in cross section along the line 5-5 of FIG. 4 showing the stellate center cut of the diaphragm.

FIG. 6 is a cross-sectional side elevation view of an alternative embodiment of the pin cap of the present invention with a plurality of diaphragms affixed to the body of the pin cap.

FIG. 7 is a cross-sectional side elevation view of a further alternative embodiment of the pin cap wherein the plurality of diaphragms are free floating between internal ledges within the body of the pin cap. This embodiment may be desirable when the diaphragms are formed of a different material from the body of the pin cap.

FIG. 8 is a cross-sectional perspective view of an embodiment of the pin cap wherein the internal side of the end cap of the pin cap is textured with a “waffled” surface to provide a point of fixation for the pin.

FIG. 9 is a cross-sectional side elevation view of the embodiment of FIG. 8 along the line 9-9 of FIG. 8 showing the pin in shadow outline being fixated by the waffled internal side of the end cap.

### DETAILED DESCRIPTION OF THE INVENTION

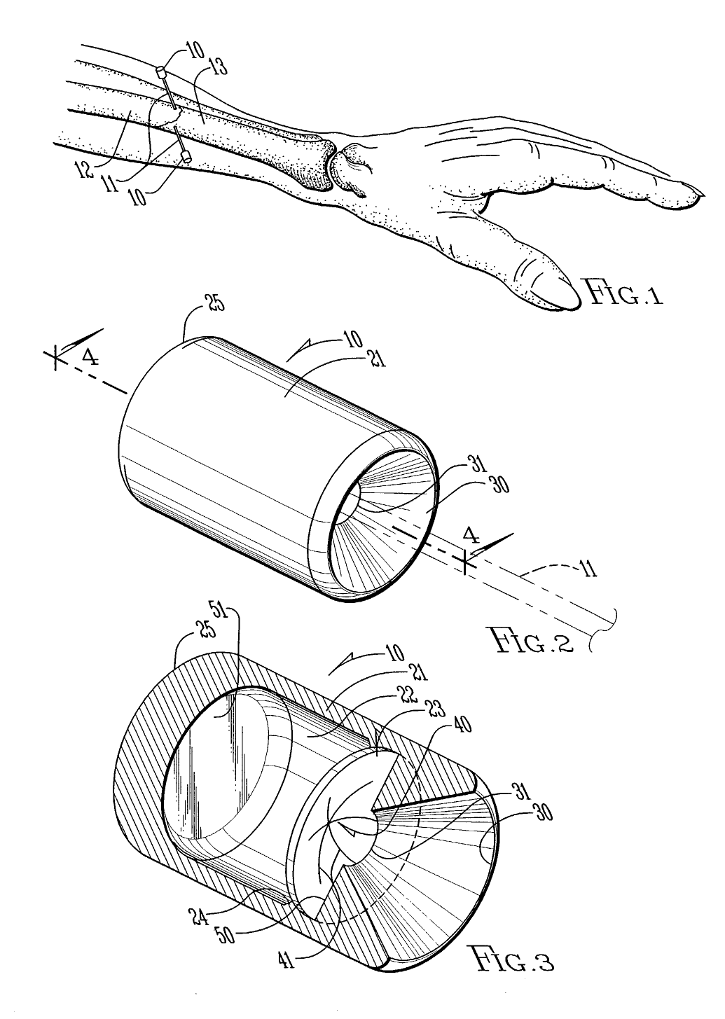

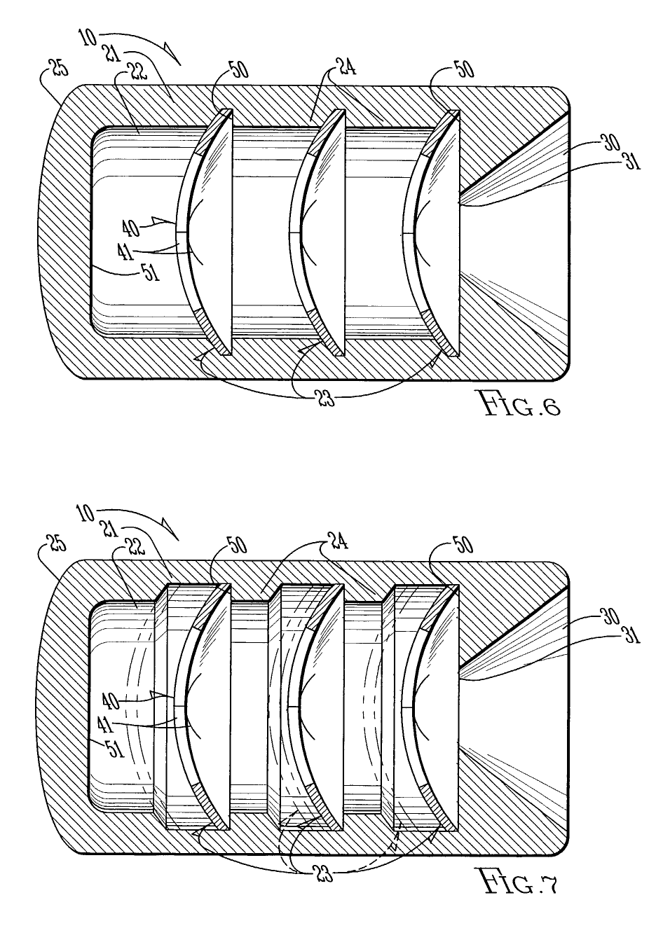

With reference to FIGS. 1-9, the preferred embodiments of the present invention may be described. As shown in FIG. 1, the invention is a pin cap 10 which fits onto the exposed ends of a pin 11. While the preferred embodiment of the present invention is described herein with respect to a surgical pin and is particularly effective in that application, the invention is not so limited and may be used with other “pins” as defined above. The pin 11 may be used, for example as shown in FIG. 1, to fix two pieces of fractured bone 12, 13. A single pin cap 10 of the present invention has the capability of fitting a range of pin sizes and can be easily applied and removed multiple times without tools.

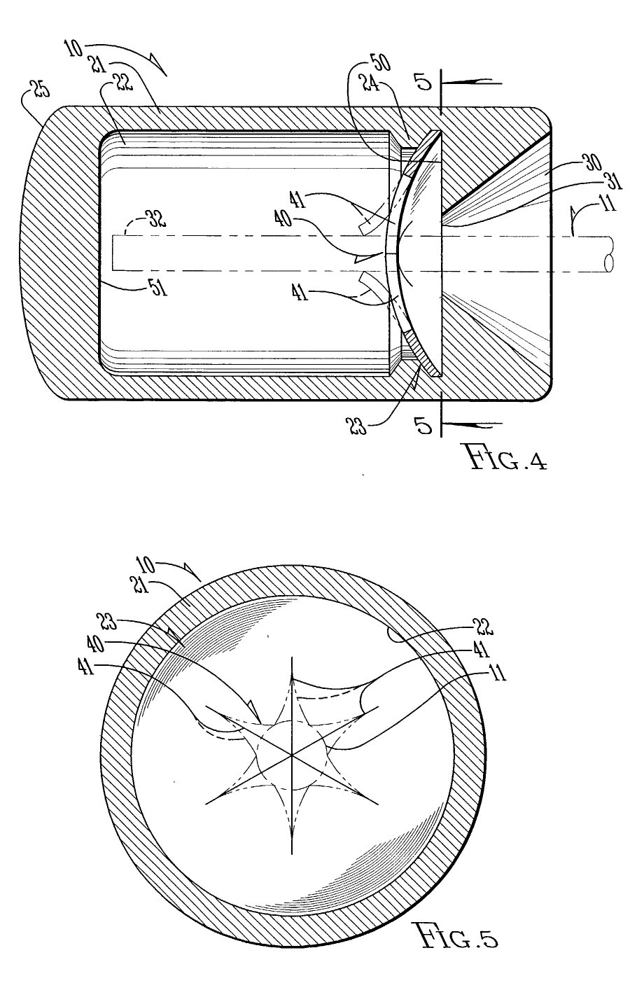

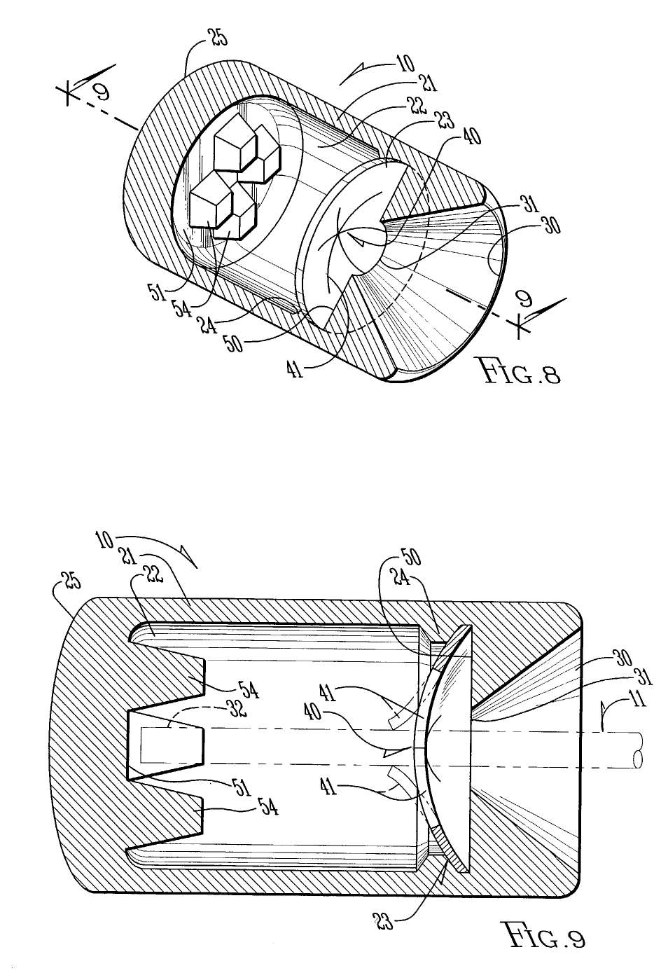

With reference to FIGS. 2 and 3, the pin cap 10 comprises a compressible cylindrical body 21 having a hollow interior 22. Inside the body 21 there is at least one diaphragm 23. If there are a plurality of diaphragms 23, they are desirably spaced longitudinally through the body 21. In one embodiment shown in FIG. 6, the diaphragms 23 are fixed to the body 21. For example, the diaphragms 23 may be formed in one piece with the body 21 or may be formed separately from the body 21 and affixed to the body 21 by any means known in the art. In the alternative embodiment of FIG. 7, the diaphragms 23 are free floating between internal ledges 24 within the body 21.

Referring to FIG. 4, one end of the body 21 is closed with an end cap 25. The opposite end of the body 21 has a tapered entry 30 with an opening 31. The tapered entry 30 funnels the end 32 of the pin 11 through the diaphragms 23 along their central axes. Additionally the tapered entry 30 is provided with a ledge 33 which prevents the diaphragms 23 from being pulled out of the body 21.

Each of the diaphragms 23 has a stellate center cut 40. The stellate center cut 40 may comprise a plurality of straight cuts 41 through the central axis of the diaphragm 23. The straight cuts 41 desirably number from 3 to 12. The number of straight cuts 41 may be selected based on the materials from which the diaphragm 23 is formed and the desired resistance to pull out of the pin cap 10 from the pin 11.

The diaphragms 23 are also characterized in that each diaphragm 23, as viewed from the tapered entry 30, is concave. Compression of the compressible elastic body 21 also allows compression of the edges of the elastic diaphragms 23, thereby opening the stellate center cut 40 into a number of flaps for passage of the pin 11 as shown in FIG. 4. Relaxation on the body 21 allows the opening of the stellate center cut 40 to close down securely on the pin 11 thereby holding it in place. The nature of the concave curve on the diaphragm 23 further strengthens the intrinsic pull out resistance.

The pin cap 10 can be easily removed by applying pinch pressure to the compressible elastic body 21 allowing the cap 10 to be removed from the pin 11. It may be reused on the same person for multiple applications without deformation of the diaphragm. However, routine care around the pin cap 10, including dressing changes, will not dislodge the pin cap 10. Pull off resistance is desirably limited so that the pin cap 10 can be dislodged before the pin 11 is pulled from its position in the patient's body.

The resistance of the diaphragm 23 to pull out can be adjusted by selecting the number of diaphragms 23, the number of straight cuts 41 comprising the stellate center cut in each diaphragm 23, and the material used to form the body 21 and diaphragms 23. Although a single pin cap 10 can be made to accommodate a range of pin sizes, significant changes in pin or wire diameters can be accommodated by a step-wise increase in the size of a range of pin caps 10. One pin cap 10 can be designed to fit 3 to 6 pin diameters. The inventory of pin caps 10 may be considerably reduced from the prior art pin cap which requires a specific size pin cap for each size pin. Further, cap application and removal require no tools to make adjustments upon each use of the pin cap 10.

The pin cap 10 may be molded from a high temperature plastic using injection molding so that the diaphragms 23 as shown in FIG. 6 are an integral part of the cap 10. The cap 10 is desirably compressible using standard pinch pressures which could be applied by one's thumb and index finger. However, the cap 10 should desirably resist removal at forces less than standard pinch forces.

As an alternative to molding the diaphragms 23 into the body 21 of the pin cap 10 or otherwise firmly affixing the diaphragms 23 to the body 21 as described above, the diaphragms 23 may be free floating between internal ledges 24 as shown in FIG. 7.

The cap 10 may be slipped onto a protruding wire 11 by applying compression to the outside of the body 21. The tapered entry 30 not only provides a gliding surface to assist in the insertion of the cap 10 onto a wire 11 but also provides a point of fixation once the cap is inserted up to the entry ledge 50 formed by the interior portion of the tapered entry 30. While this is not necessary for securing the cap 10, it improves the fixation. The ledge 50 of the tapered entry 30 also prevents the diaphragms 23 from being pulled out of the body 21 when the cap 10 is removed from the pin 11. When pressure is applied to the body 21, the diaphragms 23 gap open slightly to allow insertion of the cap 10 onto the pin 11. The end 32 of the pin 11 stops against the internal side 51 of the end cap 25. The internal side 51 of the end cap 25 may be rounded to assist in the fixation of the end 32 of the pin 11. The internal side 51 of the end cap 25 may also be textured with a lattice work or waffled finish which aids in the capture the inserted pin 11 and provides a point of fixation. A waffled internal side 54 of the end cap 25 is shown in FIG. 9.

When compression is removed from the body 21 of the pin cap 10, the stellate center cuts 40 of the diaphragms 23 relax and close onto the inserted pin 10. The concave shape of the diaphragms 23 and the elastic material properties of the diaphragms 23 provide resistance to removal of the pin cap 10 unless desired or until high forces are applied to the cap 10.

In the forms of the invention described above, it is desirable that all portions of the pin cap be made of high temperature plastics with resistance varied by the thickness of the plastic in the body 21 and the diaphragms 23. Additional changes in resistance can be made by changing the number of diaphragms 23 and the number of straight cuts 41 in the stellate center cuts 40 of the diaphragms 23. Alternatively, other materials, such as metal, can also be employed in the body 21 or in the diaphragms 23 to improve pull out resistance or durability of the cap 10 in particular applications.

The present invention has been described with reference to certain preferred and alternative embodiments that are intended to be exemplary only and not limiting to the full scope of the present invention as set forth in the appended claims.

What is claimed is:

1. A pin cap for covering the end of a pin, comprising:
a compressible body having a first end and a second end, an end cap closing said first end and said second end being open; and
at least one compressible diaphragm located within said body and having a stellate center cut whereby manual pressure on said body compresses said compressible diaphragm causing said stellate center cut to open to allow the passage of the pin through said diaphragm and relaxation of manual pressure on said body allows said stellate center cut to close onto the end of the pin.

2. The pin cap of claim 1 wherein said diaphragm is concave with respect to said open end.

3. The pin cap of claim 1 wherein said open end comprises a tapered entry.

4. The pin cap of claim 3 wherein said tapered entry further comprises an entry ledge for resisting said diaphragm being pulled out of said body.

5. The pin cap of claim 1 wherein said end cap is rounded.

6. The pin cap of claim 1 wherein said end cap has an interior side and further wherein said interior side is textured to provide a point of fixation for the end of the pin.

7. The pin cap of claim 1 wherein said diaphragm is integral with said body.

8. The pin cap of claim 1 wherein said body is provided with at least two internal ledges and said diaphragm is free floating between said internal ledges.

9. A pin cap for covering the end of a pin, comprising:
a compressible body having a first end and a second end, an end cap closing said first end and said second end comprising a tapered entry having a ledge for resisting said diaphragm being pulled out of said body;
at least one compressible diaphragm located within said body, wherein said diaphragm is concave with respect to said open end and further wherein said diaphragm has a stellate center cut whereby manual pressure on said body compresses said compressible diaphragm causing said stellate center cut to open to allow the passage of the pin through said diaphragm and relaxation of manual pressure on said body allows said stellate center cut to close onto the end of the pin.

10. The pin cap of claim 9 wherein said end cap is rounded.

11. The pin cap of claim 9 wherein said end cap has an interior side and further wherein said interior side is textured to provide a point of fixation for the end of the pin.

12. The pin cap of claim 9 wherein said diaphragm is integral with said body.

13. The pin cap of claim 9 wherein said body is provided with at least two internal ledges and said diaphragm is free floating between said ledges.
